(19) United States
(12) Patent Application Publication
(10) Pub. No.: US 2008/0155903 A1
(43) Pub. Date: Jul. 3, 2008

(54) Composite Polishing Pad

(75) Inventor: Spencer Preston, Manteca, CA (US)

Correspondence Address: SNELL & WILMER L.L.P. (Main), 400 EAST VAN BUREN, ONE ARIZONA CENTER, PHOENIX, AZ, 85004-2202, US

(73) Assignee: RIMPAD TECH LTD., Rocklin, CA (US)

(21) Appl. No.: 12/049,872

(22) Filed: Mar. 17, 2008

Related U.S. Application Data
(62) Division of application No. 11/684,523, filed on Mar. 9, 2007.
(60) Provisional application No. 60/780,773, filed on Mar. 9, 2006.

(51) Int. Cl. C09K 3/14

(52) U.S. Cl. 51/298

(57) ABSTRACT

A polishing pad having an optically clear bottom layer and a closed cell top layer where the interface between the top and bottom layers is only a urethane to urethane interface. Grooves may be machined into the top layer or through the top layer and into the bottom layer.

### CROSS-REFERENCE TO RELATED APPLICATIONS

This application is a divisional of U.S. patent application Ser. No. 11/684,523, filed Mar. 9, 2007 which is entitled “COMPOSITE POLISHING PAD”, which includes subject matter that is related to and claims priority from U.S. Provisional Patent Application Ser. No. 60/780,773, filed Mar. 9, 2006 which is entitled, “COMPOSITE CMP PAD”, both of which are hereby incorporated by reference.

### FIELD OF INVENTION

This invention generally relates to polishing pads and methods for making the same.

More particularly, this invention relates to a composite chemical mechanical polishing (CMP) pad having a bottom optically clear layer and a closed cell polyurethane top layer wherein the interface between the two layers comprises only a urethane to urethane bond.

### BACKGROUND OF THE INVENTION

It is important to obtain specific performance criteria for the rate of removal of material, the flatness of the polished object, and other such factors in the field of polishing. These factors can be greatly impacted by the type of material used to polish an object. In the semiconductor industry, polishing pads are often used to polish raw wafers and for performing chemical mechanical planarization.

Many polishing methods and polishing materials have been used for abrading and/or polishing the surface of various materials and objects. Many materials use grooves contained in their surfaces and several methods include applying slurry to the grooved surfaces. However, the goals of planarization uniformity and consistency during polishing remain high. Accordingly, there is always a need for improved polishing pads that increase planarization uniformity and consistency during polishing.

### SUMMARY OF THE INVENTION

The present invention is directed to a composite polishing pad that includes an optically clear bottom layer and a closed cell polyurethane top layer where the interface between the top and bottom layers comprises only a urethane to urethane bond. Grooves may be machined into one or more of the top and bottom layers of the composite pad.

The invention is also directed to a method for making a polishing pad which includes the steps of providing a solid urethane piece having a cavity contained within it where the solid urethane piece has a first Shore D hardness, pouring a liquid urethane formulation into the cavity of the solid urethane piece where the liquid urethane formulation has a hardness formulation having a second Shore D hardness, allowing the liquid urethane formulation to solidify and cure, machining the solid urethane piece to a desired thickness, and machining the solidified liquid urethane formulation to a desired thickness. The method may also include the step of machining grooves into the solid urethane piece and/or the solidified liquid urethane formulation.

### BRIEF DESCRIPTION OF THE DRAWINGS

A more complete understanding of the present invention may be derived by referring to the detailed description and the claims when considered in connection with the Figures, wherein like reference numbers refer to similar elements throughout the Figures, and:

FIG. 1 is a cross sectional view of the polishing pad of the present invention;

FIG. 2 is a top plan view of the polishing pad of the present invention having grooves with a wafer shown on the surface of the pad;

FIG. 3 shows a top plan view of the polishing pad of the present invention positioned on a clear polishing table using tape;

FIG. 4 is a graph showing high edge removal rate; and

FIG. 5 is a graph showing low edge removal rate.

### DETAILED DESCRIPTION

While the exemplary embodiments herein are described in sufficient detail to enable those skilled in the art to practice the invention, it should be understood that other embodiments may be realized and that logical and mechanical changes may be made without departing from the spirit and scope of the invention. Thus, the following detailed description is presented for purposes of illustration only and not of limitation.

There are two innovative attributes disclosed in this invention.

The first being a CMP pad with 360 degree polishing table rotation optical accessibility to the wafer surface being polished. This is accomplished without interrupting the polishing surface.

The pad has a top surface which includes a series of concentric grooves dimensioned to facility the CMP Polishing process.

Cross section of the present invention showing the grooves. The black is the polishing surface consisting of closed cell polyurethane. The white is optically clear polyurethane.

The polishing surface (black) is a harder urethane (shrore D 60) than the bottom urethane (Shore D 20-50). The combination of the two materials make up the top surface of the CMP polishing pad.

This type for groove configuration is designed to allow the normal polishing surface the ability to have independent loading in the radial direction while maintaining the long range planarization characteristics in the radial direction.

This invention is designed to be used with a rotational CMP polishing tool which has a clear polishing table. The current invention of the Polishing pad when used with a clear polishing table is capable of providing 360 degrees of accessibility to the polishing surface of a wafer while it is being polished.

FIG. 2 shows a top view of the polishing pad with grooves with a wafer on the surface. During the polishing the polishing pad is rotated while the wafer remains stationary rotating on its own axis.

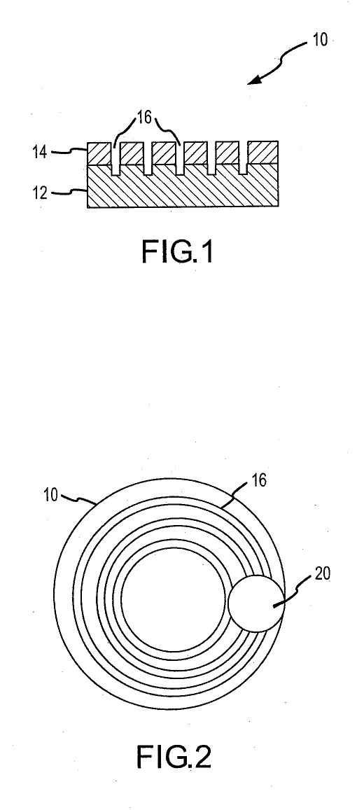

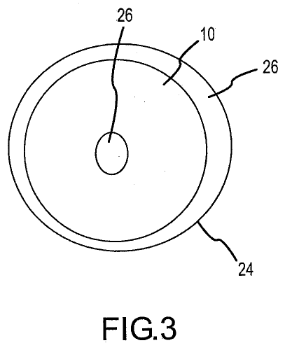

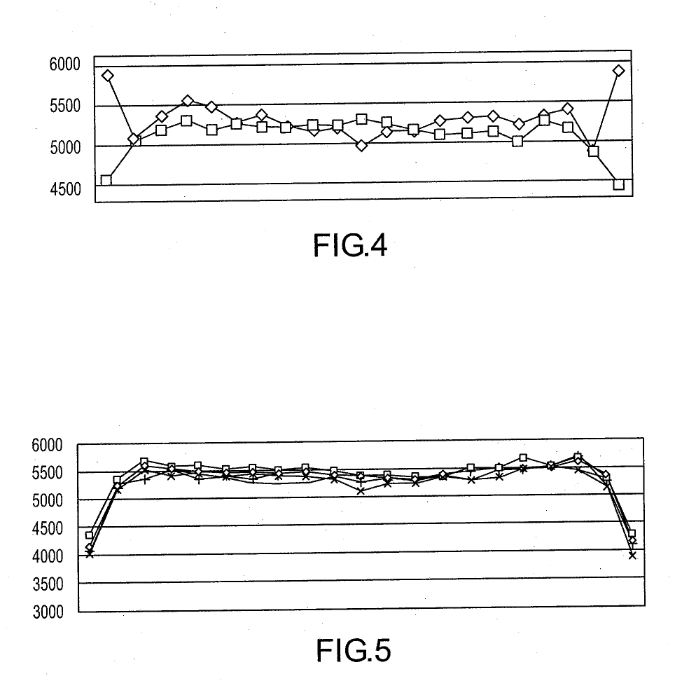

The black rings represent the top of the polishing surface the white rings represent the bottom of the grooves as shown in the cross section of FIG. 1.

It can be clearly seen that if the polishing pad is fixed to a clear polishing table that light can be passed through the table and through the pad to reflect off the wafer without interrupting the normal polishing surface. Access to the wafer is 100% of the time and 360 degrees of table rotation.

Please note that in FIG. 1 the interface between the closed cell urethane and the clear urethane is urethane to urethane bonds. These bonds are formed by pouring a reacted urethane formulation into a cavity formed in the back side of a solid urethane part of a different hardness formulation. There is no mold release present to inhibit the liquid urethane from bonding with the surface it touches. The liquid urethane is allowed to solidify and completely cure. The composite material is then machined flat and to the desired thickness of the clear urethane. The composite is then thinned to provide the desired thickness of the closed cell urethane. The grooves are then machined to the desired depth, a depth which is greater than the thickness of the closed cell urethane polishing surface.

Please note that the top surface of the lower urethane never sees anything other than the lower surface to the solid urethane in its solid state.

Please note there is no means of adhering the dissimilar materials together other than the natural urethane to urethane bonds which become permanent. There is no tape involved at the interface.

Please note that in one embodiment where the first attribute is not needed (the light transmissive attribute) the grooves may not need to penetrate completely through the closed cell urethane thickness.

With the Composite pad having groove depths greater than the closed cell thickness the bottom of the grooves is a clear elastomeric urethane material capable of transmitting a light beam through the composite pad without interrupting the normal polishing surface. The light is then capable of reflecting off the surface of the wafer being polished and reflected back through the groove to the clear urethane.

There are three methods to fix the composite pad to the clear polishing table:

The first is to use a double side tape such as 442KW a 3M product. This tape adheres to the side away from the grooved surface with one side of the tape and the other side of the tape adheres to the clear polishing table. The draw back from using the 442KW is that this product is not completely clear and can interfere with the light beam in both directions. Because of this a clear double side tape should be used.

The second method of adhering the composite pad to the clear polishing table resolves the light transmission problem by providing the 442KW only to the outer and inner regions of the polishing pad. Areas where the wafer is not present. The back side of the composite pad can be machined to provide for a flat surface with the tape installed.

With this lamination the light is capable of passing through the clear table directly to the clear urethane and reflecting off the wafer to the sensor located below the table.

A third method of lamination is to install fastening devices on the back side of the composite pad. These could be snaps, screws clamps etc that line up with mating fasteners located on the clear polishing table. With this method the pad is helps secure and is fixed to the clear polishing table. It is also possible in this method to apply a light transmission fluid between the composite pad and the clear table to enhance the light transmission by eliminating one of the refracting surfaces at the interface.

Once the pad is fixed to the table the wafer is positioned to polish the polishing machine dispenses polishing slurry to the pad. The grooves fill with slurry. This creates irregular light transmission making it difficult to analyze the reflected light from the wafer. The composite pad of the present invention minimizes the effect of the slurry in the grooves by monitoring the light signal 100% of the polishing time or 360 degrees of table rotation. With this type of observation it is possible to filter out the noise from the slurry in the grooves.

The second attribute of the current invention is to provide a polishing surface with a hard enough surface to provide a reference for planarization while also absorbing any out of perfectly flat topographies that exist in the system. This configuration of hard polishing surface with a shock absorbing bulk material is also advantageous in controlling the polishing rate at the very edge of the wafer.

Please note the high edge removal rate on the top wafer profile versus the low edge removal rate on the lower profile. These wafers were measured at 4 mm edge exclusion. The high edge removal rate profile was produced without the use of a shock absorbing composite.

The low edge removal rate wafer profile was produced with a shock absorbing composite prototype material.

Please not the low edge removal rate prototype was repeated with these 4 wafer profiles.

Additional attributes. This invention is of benefit on each attribute alone. That is to say the table does not need to be clear to take advantage of the independent pressure loading in the Composite Pad. The lower urethane does not have to be clear to take advantage of only the independent radial loading. Not all of the grooves need to penetrate through the closed cell urethane to provide the edge removal rate control and with in wafer uniformity benefits disclosed in this invention.

A composite pad capable of 360 degrees of endpoint detection monitoring.

This allows for EPD with slurry in the grooves because the analysis is continuous and can filter out the slurry noise more accurately than the current EPD window technology.

Using a light source mounted below a clear polishing table.

This improvement enables #1.

A composite pad with independent polishing surface pressure loading in the radial table direction while maintaining the long range planarization characteristics of a planarizing pad in the radial direction.

With in wafer non uniformity can be improved because the pressure loading is independent in the radial direction. The long range planarization characteristics do not change. The current invention composite pad will improve the shorten distance from the edge of the wafer that a steady state removal rate can be achieved.

Elimination of a tape layer to fabricate a composite pad.

With no tape layer holding the pad surfaces together the pad has an elastic behavior. This allows for more consistent response to loading variations.

Pad mounting fasteners in the table and mating mounting fasteners on the pad.

The fastener idea is an improvement over taping the pad to the table for ease of removal and enables improved light transmitting characteristics. It is also possible to provide a vacuum table for the polishing table and securing the pad to the table via vacuum. The pad in the case of vacuum can be included in combination with other fastening devises other than tape.

The invention has huge improvements to the performance of the pad for CMP . . . one can control the hardness of the lower half of the composite pad to control non-uniformity, however there is no “gluing” the pad together, so the interaction of glue/Mylar (part of the glue layer)/pad/CMP slurry or water is eliminated. It allows us to put grooves much deeper into the top layer than on pads that are first made and then glued together. Also, by producing this bottom layer of the composite pad in a “clear” version, one can put grooves deep enough in the top layer to allow optical transmission (useful for end point lasers in the CMP tool platen) without causing a disruption of the polishing surface . . . making the performance uninterrupted by a pad window.

In the foregoing specification, the invention has been described with reference to specific embodiments. However, it may be appreciated that various modifications and changes may be made without departing from the scope of the invention. The specification and figures are to be regarded in an illustrative manner, rather than a restrictive one, and all such modifications are intended to be included within the scope of invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A method for making a polishing pad comprising the steps of:
providing a solid urethane piece having a cavity contained therein wherein said solid urethane piece comprises a first Shore D hardness;
pouring a liquid urethane formulation into the cavity of the solid urethane piece wherein the liquid urethane formulation comprises a hardness formulation having a second Shore D hardness;
allowing the liquid urethane formulation to solidify and cure;
machining the solid urethane piece to a desired thickness; and
machining the solidified liquid urethane formulation to a desired thickness.

2. The method of claim 1 further comprising the step of machining grooves into at least one of the solid urethane piece and the solidified liquid urethane formulation.

3. The method of claim 2 wherein the step of machining grooves comprises the step of machining grooves into both the solid urethane piece and the solidified liquid urethane formulation.

4. The method of claim 1 wherein values of the first Shore D hardness and the second Shore D hardness are distinct from one another.
